(19) United States
(12) Patent Application Publication
(10) Pub. No.: US 2024/0204673 A1
(43) Pub. Date: Jun. 20, 2024

(54) UNIVERSAL POWER ELECTRONICS BUILDING BLOCK (U-PEBB) BASED DELTA-CONNECTED CASCADE MULTILEVEL CONVERTER

(71) Applicant: The Florida State University Research Foundation, Inc., Tallahassee, FL (US)

(72) Inventors: Fang Peng, Tallahassee, FL (US); Hui Li, Tallahassee, FL (US)

(21) Appl. No.: 18/543,335

(22) Filed: Dec. 18, 2023

Related U.S. Application Data
(60) Provisional application No. 63/433,205, filed on Dec. 16, 2022.

(51) Int. Cl. H02M 3/335

(52) U.S. Cl. CPC H02M 3/3353

(57) ABSTRACT

The disclosure relates to a devices, systems and methods implementing a delta-connected cascaded multilevel converter comprised of a plurality of U-PEBBs, each U-PEBB comprising a bi-directional and isolated ac to dc converter module using Si or SiC power semiconductor devices.

### CROSS REFERENCE TO RELATED APPLICATION

This application claims priority to and benefit of U.S. Provisional Patent Application Ser. No. 63/433,205 filed Dec. 16, 2022, which is fully incorporated by reference.

### BACKGROUND

Conventional power converters in the medium voltage distribution systems such as extreme fast charging station (XFC) systems usually require line-frequency step down transformers and different types of converters/inverters to charge electric vehicles from utility companies various medium voltage distribution systems. This presents a challenge to the wide-spread use of XFC stations, as the space is usually limited. In addition, the high charging rate may lead to significant negative impacts on the grid when charging multiple vehicles at extreme fast charging rates. All of these will greatly increase the installation and operational costs of XFC systems/stations which will hinder the growth of vehicle electrification. Similar issues exist for other grid-tied converters including PV inverters, static synchronous compensator (SATCOM) systems, and battery storage systems.

Therefore, what is needed are devices, methods, and systems that overcome challenges in the art, some of which are described above.

### SUMMARY

Disclosed and described herein are embodiments of devices, methods, and systems of a delta-connected cascade multilevel converter comprised of one or more universal power electronics building blocks (U-PEBBs). Each U-PEBB comprises a bi-directional and isolated ac to dc converter module using semiconductor devices such as Si or SiC devices to configure all XFC systems, solid state transformers (SSTs), grid-tied converters interfacing with renewable energy and storage elements and many other applications such as SATCOM, static var compensators (SVC), Vehicle-to-Everything (V2X) systems and the like using series and/or parallel connections of the disclosed U-PEBBs fed directly from a medium voltage (4,160 V to 14.4 kV) utility distribution system with great ease. The system configurations/topologies disclosed herein do not need any other power electronics building block (or parts), thus revolutionizing the current installation and operation of XFC systems/stations of electrified vehicles and reducing manufacturing and installation costs. The disclosed U-PEBB embodiments have very high power density, high efficiency, and low costs.

Considering the flexibility of embedding local energy storage allowed in U-PEBB, and balanced-guaranteed three phase current from the grid with power factor control and grid support such as reactive power and voltage compensation when needed, not only will the negative impact of high penetration of power electronics converters to the grid be avoided but also the grid support function can be provided when needed.

In one aspect, a universal power electronics building block (U-PEBB) is described, disclosed and/or shown herein.

In another aspect, a delta-connected cascaded multilevel converter comprised of one or more of the U-PEBBs is described, disclosed and/or shown herein.

In another aspect, each of the U-PEBBs that comprise the delta-connected cascaded multilevel converter described, disclosed and/or shown herein is comprised of a bi-directional and isolated ac to dc converter module.

In another aspect, bi-directional and isolated ac to dc converter module described, disclosed and/or shown herein is comprised of Si and/or SiC power semiconductor devices.

In another aspect, U-PEBB described, disclosed and/or shown herein further comprises a local battery.

Other objects and advantages will become apparent to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

The accompanying drawings, which are incorporated in and constitute a part of this specification, illustrate embodiments and together with the description, serve to explain the principles of the disclosed technology.

FIG. 1 illustrates and exemplary topology of a U-PEBB based delta-connected cascaded multilevel converter.

FIG. 2 is a schematic of an exemplary U-PEBB and the Si and/or SiC components that comprise an exemplary U-PEBB, including an optional local battery.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

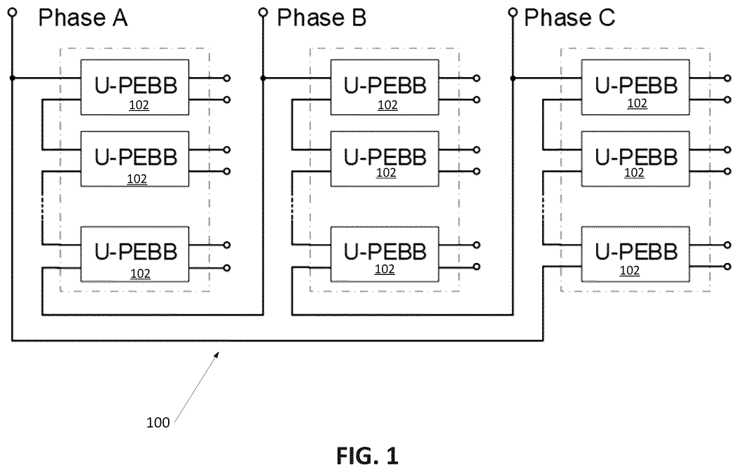

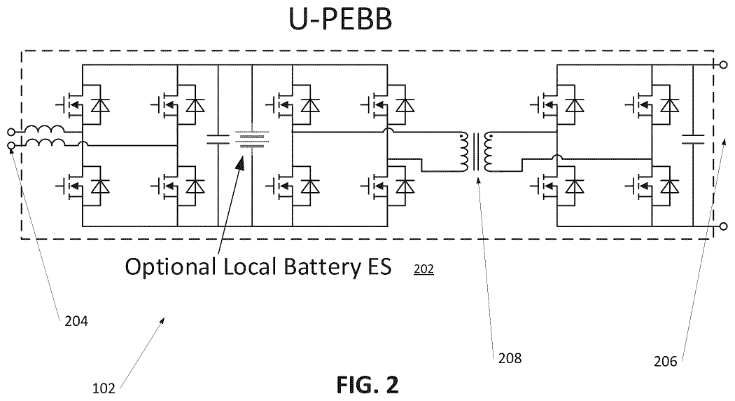

The topology of an exemplary U-PEBB based delta-connected cascaded multilevel converter 100 is illustrated in FIG. 1, where each U-PEBB 102 is comprised of a bi-directional and isolated ac to dc converter module using Si or SiC semiconductor devices. For example, as shown in FIG. 2, one embodiment of a U-PEBB 102 comprises a DC input side 204, an AC output side 206, and a transformer 208 connecting the DC input side 204 to the AC output side 206. In one aspect, the DC input side 204 comprises two sets of SiC or Si MOSFETS connected to the DC input, as shown in FIG. 2. Further comprising the DC input side 204 are two additional set of Si or SIC MOSFETS connected to the input of the transformer 208. A capacitor 210 is connected in parallel between the two different sets of MOSFETS of the DC input side 204. The DC input side 204 converts the DC input to an AC signal. The transformer 208 steps up or down the voltage of the DC input side 204. The transformed AC voltage is output on the AC output side 206, which further comprises two sets of MOSFETS connected to the output of the transformer 208. The U-PUBB 102 can be designed for various voltages and currents by selecting desired MOSFET ratings, gate switching signals, capacitor and transformer selection. In some instances, the DC input may include inductors.

Utilizing the disclosed embodiments of a U-PEBB, the converter system 100 can be configured for wide applications from solid state transformers (SSTs) to extreme fast charging stations (XFCs) to grid-tied converters interfacing with renewable energy and storage elements, as well as many other applications including static synchronous compensator (SATCOM) and static var compensators, all directly from a medium voltage grid by plug-and-play series/paralleling connection of these U-PEBBs. Therefore, the manufacturing and installation costs will be reduced significantly. In addition, the disclosed U-PEBB 102 itself has very high power density, high efficiency, and is low cost. Considering the flexibility of embedding local energy storage allowed in U-PEBB, and balanced-guaranteed three phase current from the grid with power factor control and grid support such as reactive power and voltage compensation when needed, not only will the negative impact of high penetration of power electronics converters to the grid be avoided but also the grid support function can be provided when needed.

FIG. 2 is a schematic of Si and/or SiC components that comprise an exemplary U-PEBB, including an optional local battery 202.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

What is claimed is:

1. A universal power electronics building block (U-PEBB) comprising:
an input side,
an output side, and
a transformer connecting the input side to the output side,
wherein a DC voltage and current input to the input side is converted to an AC output on the output side, and wherein the U-PEBB comprises a bi-directional and isolated ac to dc converter module.

2. The U-PEBB of claim 1, wherein the input side comprises:
two SiC or Si MOSFETS connected to a positive side of an input;
two SiC or Si MOSFETS connected to a negative side of the input;
two Si or SIC MOSFETS connected to a positive input of the transformer; and
two Si or SIC MOSFETS connected to a negative input of the transformer, wherein
the two SiC or Si MOSFETS connected to the positive side of the input are connected in parallel to the two SiC or Si MOSFETS connected to the negative side of the input, the two SiC or Si MOSFETS connected to the negative side of the input are connected in parallel to the two Si or SIC MOSFETS connected to the positive input of the transformer, and the two Si or SiC MOSFETS connected to the positive input of the transformer are connected in parallel to the two Si or SIC MOSFETS connected to the negative input of the transformer, and wherein
an input side capacitor is connected in parallel between the two SiC or Si MOSFETS connected to the negative side of the input and the two Si or SiC MOSFETS connected to the positive input of the transformer.

3. The U-PEBB of claim 2, wherein the output side comprises:
two Si or SIC MOSFETS connected to a positive output of the transformer;
two Si or SiC MOSFETS connected to a negative output of the transformer; and
an output side capacitor connected in parallel to the two Si or SiC MOSFETS connected to a negative output of the transformer, wherein
the two Si or SiC MOSFETS connected to the positive output of the transformer are connected in parallel to the two Si or SIC MOSFETS connected to the negative output of the transformer.

4. The U-PEBB of claim 3, wherein the U-PEBB is designed for various voltages and currents by selecting desired MOSFET ratings, gate switching signals, and selection of ratings for the input side capacitor, the output side capacitor, and ratings of the transformer.

5. The U-PEBB of claim 3, further comprising an inductor on the positive side of the input and an inductor on the negative side of the input.

6. The U-PEBB of claim 3, further comprising a local battery, wherein the local battery is connected in parallel between between the two SiC or Si MOSFETS connected to the negative side of the input and the two Si or SiC MOSFETS connected to the positive input of the transformer.

7. A delta-connected cascaded multilevel converter comprised of:
a plurality of universal power electronics building block (U-PEBB), each U-PEBB comprising:
an input side,
an output side, and
a transformer connecting the input side to the output side,
wherein a DC voltage and current input to the input side is converted to an AC output on the output side, and wherein the U-PEBB comprises a bi-directional and isolated ac to dc converter module.

8. The delta-connected cascaded multilevel converter of claim 7, wherein the input side of each of the plurality of U-PEBB comprises:
two SiC or Si MOSFETS connected to a positive side of an input;
two SiC or Si MOSFETS connected to a negative side of the input;
two Si or SiC MOSFETS connected to a positive input of the transformer; and
two Si or SiC MOSFETS connected to a negative input of the transformer, wherein
the two SiC or Si MOSFETS connected to the positive side of the input are connected in parallel to the two SiC or Si MOSFETS connected to the negative side of the input, the two SiC or Si MOSFETS connected to the negative side of the input are connected in parallel to the two Si or SIC MOSFETS connected to the positive input of the transformer, and the two Si or SiC MOSFETS connected to the positive input of the transformer are connected in parallel to the two Si or SIC MOSFETS connected to the negative input of the transformer, and wherein
an input side capacitor is connected in parallel between the two SiC or Si MOSFETS connected to the negative side of the input and the two Si or SiC MOSFETS connected to the positive input of the transformer.

9. The delta-connected cascaded multilevel converter of claim 8, wherein the output side of each of the plurality of U-PEBB comprises:
two Si or SiC MOSFETS connected to a positive output of the transformer;
two Si or SIC MOSFETS connected to a negative output of the transformer; and
an output side capacitor connected in parallel to the two Si or SIC MOSFETS connected to a negative output of the transformer, wherein
the two Si or SIC MOSFETS connected to the positive output of the transformer are connected in parallel to the two Si or SiC MOSFETS connected to the negative output of the transformer.

10. The delta-connected cascaded multilevel converter of claim 9, wherein each U-PEBB of the plurality of U-PEBB is designed for various voltages and currents by selecting desired MOSFET ratings, gate switching signals, and selection of ratings for the input side capacitor, the output side capacitor, and ratings of the transformer.

11. The delta-connected cascaded multilevel converter of claim 9, wherein each of the plurality of U-PEBB further comprises an inductor on the positive side of the input and an inductor on the negative side of the input.

12. The delta-connected cascaded multilevel converter of claim 9, wherein each of the plurality of U-PEBB further comprises a local battery, wherein the local battery is connected in parallel between the two SiC or Si MOSFETS connected to the negative side of the input and the two Si or SIC MOSFETS connected to the positive input of the transformer.

13. The delta-connected cascaded multilevel converter of claim 9, wherein the plurality of U-PEBB comprises nine U-PEBB, three on each phase of a delta connection.
